(19) United States
(12) Patent Application Publication
(10) Pub. No.: US 2005/0068587 A1
(43) Pub. Date: Mar. 31, 2005

(54) Monotone conversion process for color images

(76) Inventor: Ikuo Hayaishi, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/915,932

(22) Filed: Aug. 10, 2004

(30) Foreign Application Priority Data
Aug. 11, 2003 (JP) 2003-291329

(51) Int. Cl. H04N 1/40; H04N 1/56

(52) U.S. Cl. 358/3.01; 358/530; 348/35

(57) ABSTRACT

A brightness conversion equation for producing monotone image data from color image data is adjusted based on color distribution information relating to color bias of the color image data, or operating mode information associated with the color image data. The adjusted brightness conversion equation is used to convert pixel values of the color image data into pixel values representing pixel brightness in monotone image data.

### BACKGROUND OF THE INVENTION

1. Field of the Invention

This invention relates to a technique for monotone conversion of color image data.

2. Description of the Related Art

An image captured by an image creating device, such as a digital still camera, digital video camera, or scanner, is typically output (i.e. displayed or printed) by an image output device such as a monitor or printer. Image output devices widely used to date include color LCD displays and color ink jet printers, which enable users to easily utilize color images.

While color images enjoy widespread use, monotone images are desirable in a wide variety of situations as well. Monotone images, by evoking associations with old photographs for example, can create a certain unique ambience. A number of methods are utilized to convert color image data into monotone image data (see JP2002-337323A, for example).

Subject appearance is one element important in determining picture quality of an image. If the subject has a conspicuous appearance, the user can recognize the image to be an image of high picture quality. In a color image, a subject will have conspicuous appearance if the hues of the subject differ from the surrounding hues. In a monotone image, on the other hand, areas of similar brightness level are rendered with similar tone levels, even if hues differ. As a result, if color images are subjected to an unvarying monotone conversion process, there is a possibility of a low level of contrast between a subject and the surrounding area, so that monotone images of high picture quality cannot be obtained.

### SUMMARY OF THE INVENTION

An object of the present invention is to provide a technique for executing a monotone conversion process appropriate for color image data.

According to an aspect of the present invention, there is provided a first image processing device for performing monotone conversion of color image data. The device comprises: a data processing module for creating monotone image data from the color image data. The data processing module includes: a converting module for converting pixel values of the color image data into pixel brightness values of monotone image data according to a brightness conversion equation; an image data analyzing module for the color image data to create color distribution information relating to color bias in the color image data; and a brightness conversion equation adjusting module for adjusting the brightness conversion equation based on the color distribution information.

Since this first image processing device performs the monotone conversion process on the basis of color distribution information relating to color bias in the color image data, it can execute the monotone conversion process in a manner appropriate for color image data.

According to another aspect of the present invention, there is provided a second image processing device for performing monotone conversion of color image data, using color image data which has been generated by an image generating device and image data-related information which is associated with the color image data and which includes operating mode information pertaining to an operating mode of the image generating device at the time the color image data is generated The image device comprises: a data processing module for creating monotone image data from the color image data and the operating mode information. The data processing module includes: a converting module for converting pixel values of the color image data into pixel brightness values of monotone image data according to a brightness conversion equation; an operating mode determining module for analyzing the operating mode information to determine the operating mode; and a brightness conversion equation adjusting module for adjusting the brightness conversion equation based on the operating mode determined by the operating mode determining module.

Since this second image processing device performs the monotone conversion process on the basis of operating mode information, it can execute the monotone conversion process in a manner appropriate for color image data.

The invention may be realized in various embodiments, for example, an image processing method and image processing device; a computer program for realizing the functions of such a method or device; or a storage medium having such a computer program stored thereon.

These and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates an arrangement of an image output system.

FIG. 2 is a block diagram showing an arrangement of a computer.

FIGS. 3(a) and 3(b) illustrate characteristic color information generated by analysis of color image data.

FIGS. 4(a) and 4(b) illustrate adjustment of a brightness conversion equation.

FIG. 5 illustrates an exemplary monotone image.

FIGS. 6(a) and 6(b) illustrate adjustment of a brightness conversion equation.

FIG. 7 illustrates application of a plurality of brightness conversion equations to one set of color image data.

FIG. 8 illustrates an arrangement of an image data file IDF.

FIG. 9 is a block diagram showing an arrangement of a computer 200a.

FIG. 10 illustrates a brightness conversion equation.

### DESCRIPTION OF THE PREFERRED EMBODIMENT

The embodiments of the invention are described hereinbelow through several Embodiments, in the following order.
A. Device Arrangement:
B. Embodiment 1:
C. Embodiment 2:
D. Embodiment 3:
E. Embodiment 4:
F. Embodiment 5:
G. Variations:

A. Device Arrangement:

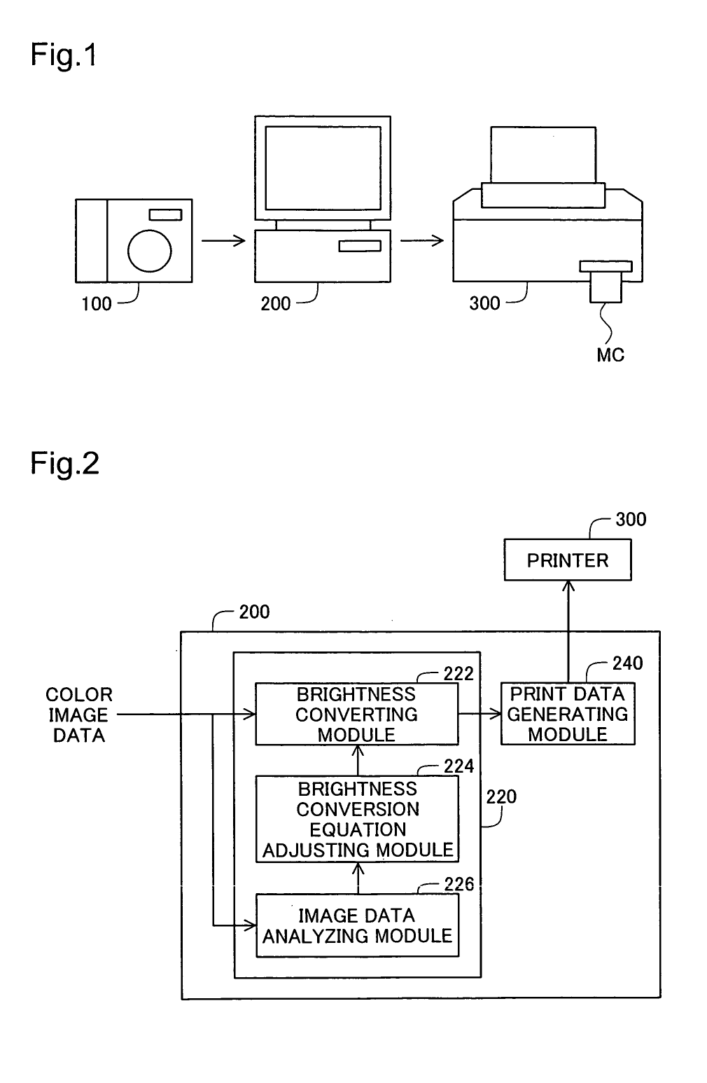

FIG. 1 illustrates an arrangement of an image output system as a Embodiment of the invention. This system 10 comprises a digital camera 100, a computer 200, and a printer 300. Digital camera 100 functions as an image creating device, computer 200 as an image processing device, and printer 300 as an image output device. Color image data crated by digital camera 100 is transferred to computer 200. Computer 200 then performs an appropriate monotone conversion process on the received color image data to create monotone image data. Computer 200 also creates print data with reference to the monotone image data, and sends it to printer 300. Printer 300 executes printing with reference to the received print data.

B. Embodiment 1:

B1. Arrangement of Image Processing Device:

FIG. 2 is a block diagram showing an arrangement of a computer 200. This computer 200 comprises a data processing module 220 and a print data generating module 240. The data processing module 220 comprises a brightness converting module 222, a brightness conversion equation adjusting module 224, and an image data analyzing module 226.

The image data analyzing module 226 analyzes color image data to be processed, and generates color distribution information relating to color bias. The brightness conversion equation adjusting module 224 adjusts a brightness conversion equation on the basis of the color distribution information. The brightness converting module 222, in accordance with a brightness conversion equation, executes a brightness conversion process on the color image data to be processed, to generate monotone image data. Detailed description of processes carried out by these functional modules is provided later.

Print data generating module 240 generates print data according to monotone image data generated by data processing module 220. In this Embodiment, print data generating module 240 executes a process to convert pixel values of monotone image data into multitone data corresponding to amounts of a plurality of inks useable by printer 300, and then performs halftone processing of the resultant multitone data to generate print data. The processing of conversion to multitone data corresponding to ink amounts is a kind of color space conversion process, and is typically executed referring to a lookup table that indicates correspondence relationships between input image data values and output ink amount values.

The print data generated by print data generating module 240 is sent to printer 300 for printing. Printer 300 has a number of constitutional elements such as a main scanning drive mechanism, sub-scanning drive mechanism, print head, print head drive circuit, control circuit and so on.

Monotone representation in this specification is not limited to representation wherein tone is reproduced using purely achromatic color (so-called “neutral” representation), but includes also representations tinged with various colors. Warm representation in which tone is represented using yellowish gray; cool representation in which tone is represented using bluish gray, or other representations in which various color sensations are created through yellow or blue hues, for example, are also possible.

Such monotone color can be represented by having the print data generating module 240 utilize any of a number of lookup tables prepared in association with various monotone representations. For example, a warm representation lookup table will be set up so that pixel values that represent brightness of pixels of monotone image data are converted to multitone data that represents tones using yellowish gray. Multitone data representing such color-tinged tones can also be referred to as monotone image data.

Data processing module 220 may also generate monotone image data for representing various color sensations. Such monotone image data can be generated by means of calculating pixel values that represent tones tinged with specific color, on the basis of pixel values that represent brightness level, generated by the brightness converting module 222. By furnishing the data processing module 220 with a monotone color adjusting module (not shown) for performing such a monotone color adjusting process, it becomes possible to generate monotone image data representing various different color sensations. In the description hereinbelow, multitone data including only a brightness component, which is created by execution of the brightness conversion process by data processing module 220, is used as monotone image data.

Some or all of the functions of the elements within computer 200 described hereinabove may be realized by means of computer programs. Such computer programs may be provided in a form recorded on a computer-readable recording medium, such as a flexible disk or CD-ROM.

B2. Monotone Conversion Process:

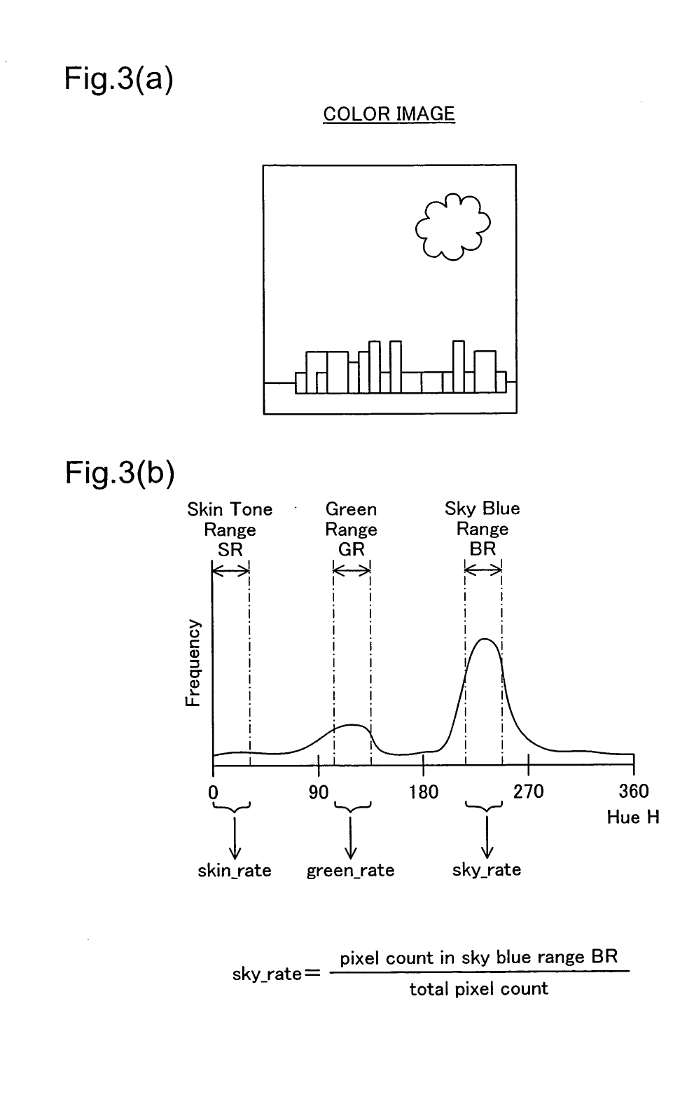

FIGS. 3(a) and (b) illustrate characteristic color information generated by analysis of color image data by image data analyzing module 226 (FIG. 2). In this Embodiment, image data analyzing module 226 calculates the proportion of sky blue color pixels, by way of characteristic color information. FIG. 3(a) shows, by way of an exemplary image, an image in which the subject is the sky above a city. FIG. 3(b) shows an exemplary hue histogram for an image having the sky as subject.

Hue H of each pixel can be calculated on the basis of the pixel value of each pixel. In this Embodiment, a conversion equation for converting from an RGB color space to an HSI color space is used to calculate hue H. The HSI color space is a color space having as parameters hue H, saturation S, and intensity I. It is also possible to use some other appropriate color space, such as the HSV (Hue/Saturation/Value) color space or HSL (Hue/Saturation/Lightness) color space, to calculate hue H.

Relationships among pixel values R, G, B represented in the RGB color space and hue H represented in the HSI color space are represented by the following equations.

$$\begin{matrix}when R = Imax , & & H = \frac{π}{3} ( \frac{G - B}{Imax - Imin} ) \\ when G = Imax , & & H = \frac{π}{3} ( 2 + \frac{B - R}{Imax - Imin} ) \\ when B = Imax , & & H = \frac{π}{3} ( 4 + \frac{R - G}{Imax - Imin} )\end{matrix} \qquad ( Eq . 1 )$$

Here, Imax=max(R, G, B), and Imin=min(R, G, B). When Imax=Imin, hue is undefined (achromatic). Where hues H<0, 2π is added to the calculated value of hue H. As a result, the value range for hue H is 0−2π; in this Embodiment, however, hue H is represented by a value range of 0° to 360°.

In this Embodiment, hue ranges are established for three characteristic colors, namely, skin tone, green, and sky blue. Specifically, a hue H range of 0° to 30° is designated as skin tone range SR, a hue range of 100° to 130° as green range GR, and a hue range of 230° to 260° as blue range BR (FIG. 3(b)). Image data analyzing module 226 calculates the proportion sky_rate of blue pixels, i.e. pixels of hue within the blue range BR. Color ranges are not necessarily limited to those mentioned above; different ranges may be established instead.

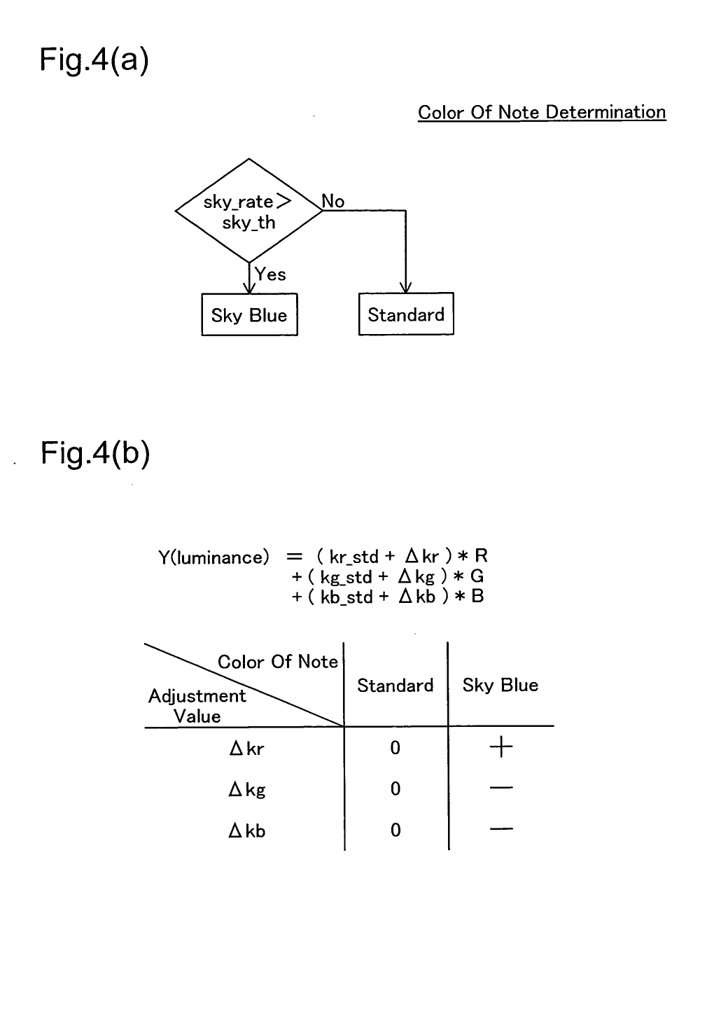

FIGS. 4(a) and 4(b) illustrate adjustment of brightness conversion equations in Embodiment 1. FIG. 4(a) illustrates a condition for determining a color of note by brightness conversion equation adjusting module 224 (FIG. 2). Here, color of note is a color characteristic of a particular subject, and refers to color readily noted by an observer of an image. In this Embodiment, brightness conversion equation adjusting module 224 determines color of note on the basis of the sky blue proportion sky_rate. Where the sky blue proportion sky_rate is greater than a blue threshold value sky_th, it is determined that the image is a landscape having the sky as the subject, i.e., that the color of note is sky blue. Where the sky blue proportion sky_rate is smaller than blue threshold value sky_th, it is determined that the image is a standard image with no identifiable color of note i.e., that the color of note is standard or unbiased.

In preferred practice, the aforementioned sky blue threshold value sky_th will be established so as to give a high degree of precision in the determination. Alternatively, a predetermined may be established as an initial value, which value can then be modified by the user.

FIG. 4(b) illustrates a brightness conversion equation adjusted by the brightness conversion equation adjusting module 224. At top in FIG. 4(b) is an example of a brightness conversion equation that indicates a relationship among the pixel values R, G, B which represent colors of pixels in color image data, and pixel value Y (termed luminance) which indicates brightness of each pixel in monotone image data.

In the brightness conversion equation of this Embodiment, luminance Y is represented by linear combination of the three pixel values R, G, B. Coefficients for the pixel values R, G, B are represented respectively as sums of standard values kr_std, kg_std, kb_std with their corresponding adjustment values Δkr, Δkg, Δkb.

At bottom on FIG. 4(b) are shown relationships among adjustment values Δkr, Δkg, Δkb and color of note. Where the color of note is standard or unbiased, adjustment values Δkr, Δkg, Δkb are all set to zero. As a result, luminance Y and pixel values R, G, B are associated by a standard relational equation based on standard values kr_std, kg_std, kb_std without using the adjustment values Δkr, Δkg, Δkb.

Where the color of note is sky blue, the adjustment value Δkr of the red component R is set to a positive value, while the adjustment values Δkg, Δkb of the green component G and blue component B are set to negative values. As a result, luminance Y of pixels having hues that approximate green or blue will be set to smaller values as compared to the case where the color of note is standard or unbiased, and luminance Y of pixels having hue that approximates red will be set to greater values as compared to the case where the color of note is standard or unbiased.

As the standard values kr_std, kg_std, kb_std, there may be used standard values, for example, values based on a conversion equation from parameter values R, G, B in an RGB color space to luminance values Y in a YCbCr color space. The magnitude of adjustment values Δkr, Δkg, Δkb will preferably be set such that the resultant monotone image does not appear unnatural, and can be determined on the basis of sensory evaluation of adjusted picture quality.

Hereinafter, such a brightness conversion equation dependent on a color of note will be referred to as the brightness conversion equation suitable for the color.

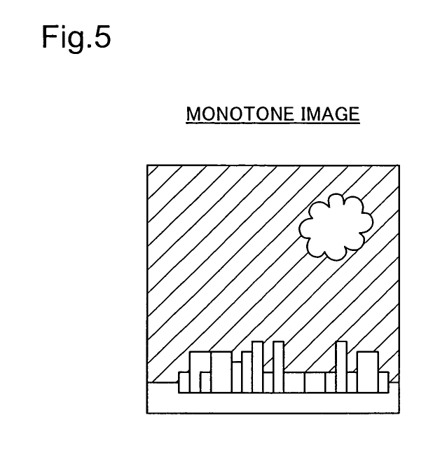

FIG. 5 illustrates an example of a monotone image of the image shown in FIG. 3(a). The image shown in FIG. 3(a) has a sky blue pixel proportion sky_rate greater than blue threshold value sky_th, so that sky blue is designated as the color of note. Accordingly, brightness converting module 222 (FIG. 2) performs a brightness conversion process using the brightness conversion equation suitable for sky blue. In this Embodiment, brightness converting module 222 applies a brightness conversion equation established in the manner shown in FIG. 4(b) to all of the pixels of the color image data being processed. As a result, in the monotone image shown in FIG. 5, the brightness of the sky is held to a lower level, and contrast with the surrounding background (in this example, the city) is enhanced. In this way, by performing the brightness conversion process using the brightness conversion equation suitable for sky blue, it is possible to derive monotone image data of high picture quality in which the sky is conspicuous.

In the Embodiment above, the brightness conversion equation can be adjusted automatically depending on the sky blue proportion sky_rate.

The sky blue proportion sky_rate in this Embodiment corresponds to the “characteristic color information” of the present invention.

C. Embodiment 2:

A point of difference from Embodiment 1 is that here, the brightness conversion equation is adjusted on the basis of pixel proportion of each of the three characteristic colors (skin tone, green, and sky blue). The arrangement of the image processing device is the same as in FIG. 2.

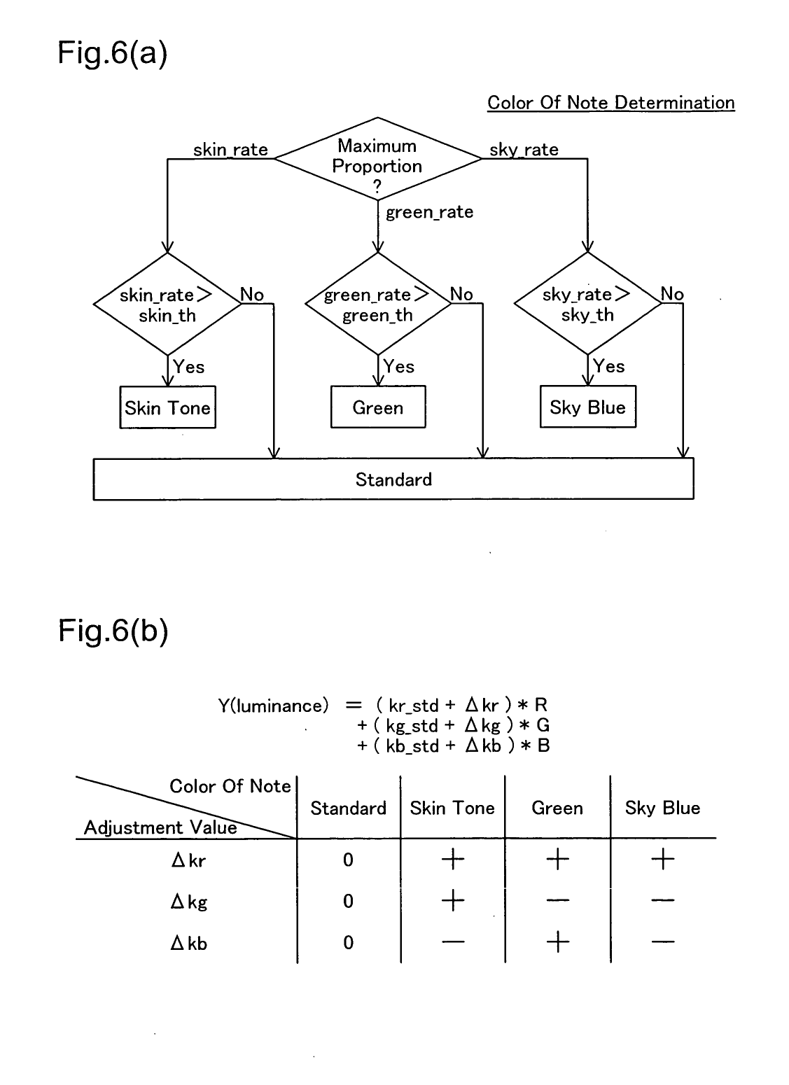

FIGS. 6(a) and 6(b) illustrate adjustment of brightness conversion equations in Embodiment 2. FIG. 6(a) illustrates a condition for determining a color of note by brightness conversion equation adjusting module 224 (FIG. 2). A difference from the example in FIG. 4(a) is that the color of note is determined on the basis of the pixel proportions skin_rate, green_rate, and sky_rate for three characteristic colors (FIG. 3(b)). These pixel proportions are calculated by the image data analyzing module 226.

In this Embodiment, one of the three characteristic colors representing the largest proportion of pixels is designated as the provisional color of note. Then, if the proportion of pixels of the provisional color of note exceeds the threshold value for the characteristic color, it is designated as the color of note. For example where the skin tone proportion skin_rate is the greatest among the three proportions skin_rate, green_rate, sky_rate , skin tone will be designated as the provisional color of note. If it is subsequently determined that the skin tone proportion skin_rate is greater than the skin tone threshold value skin_th, the color of note is determined to be skin tone, i.e. that the image is a portrait with a human subject. On the other hand, where the skin tone proportion skin_rate is smaller than the skin tone threshold value skin_th, it is determined that the color of note is standard or unbiased.

Similarly, a determination regarding green will be made in the event that the green proportion green_rate is greatest. If the green proportion green_rate is greater than the green threshold value green_th, green is designated as the color of note, and the image is determined to be a landscape image having trees or mountains as the subject. In similar fashion, a determination regarding sky blue will be made in the event that the sky blue proportion sky_rate is greatest.

FIG. 6(b) illustrates a brightness conversion equation adjusted by brightness conversion equation adjusting module 224 in this Embodiment. A difference from the example shown in FIG. 4(b) is that there are additional cases wherein the color of note is skin tone, and wherein the color of note is green.

Where the color of note is skin tone, the adjustment values Δkr, Δkg of the red component R and green component G are set to positive values, while the adjustment value Δkb of the blue component B is set to a negative value. As a result, luminance Y of pixels having hues that approximate red or green will be set to larger values as compared to the case where the color of note is standard or unbiased, and luminance Y of pixels having hue that approximates blue will be set to smaller values as compared to the case where the color of note is standard or unbiased. By adjusting the brightness conversion equation in this way, the post-conversion brightness of skin tone pixels in the image will be set to a higher level. As a result, it is possible to derive monotone image data of high picture quality in which a human subject is conspicuous.

Where the color of note is green, the adjustment value Δkg of the green component G is set to a negative value, while the adjustment values Δkr, Δkb of the red component R and blue component B are set to positive values. As a result, luminance Y of pixels having hue that approximates green will be set to smaller values as compared to the case where the color of note is standard or unbiased, and luminance Y of pixels having hues that approximate red or blue will be set to greater values as compared to the case where the color of note is standard or unbiased. By adjusting the brightness conversion equation in this way, the post-conversion brightness of green pixels in the image will be set to a lower level. As a result, it is possible to derive monotone image data of high picture quality in which vegetation or mountains are conspicuous.

In this way, with this Embodiment 2, the brightness conversion equation can be adjusted automatically depending on pixel proportion of skin tone, green, and sky blue, respectively. As a result, it is possible to carry out monotone conversion processes appropriate to various subjects which may be represented by color image data.

When determining color of note, rather than simply comparing proportions of pixels, it is possible instead when making the comparison to assign to each pixel proportion a predetermined weight associated with its characteristic color. For example, the skin tone proportion skin_rate in a portrait image tends to be smaller than the green proportion green_rate or sky blue proportion sky_rate is in a landscape image. In such cases, by weighting the skin tone proportion skin_rate to make it larger for purposes of comparison, it is possible to enhance the accuracy with which skin tone is designated as the color of note for portrait images.

It is also possible to establish an order of precedence for the characteristic colors, and to designate color of note according to this order of precedence. For example, the order of precedence may be skin tone, green, and sky blue. In this case, in the first instance, a determination by comparing pixel proportion with a threshold value is carried out for skin tone. In the event that it cannot be determined that skin tone is the color of note, a determination is then carried out for green. Subsequent determinations are carried out according to the order of precedence. By carrying out determination of color of note according to an order of precedence in this manner, it is possible to improve the accuracy of determination of color of note for color image data of various kinds.

D. Embodiment 3:

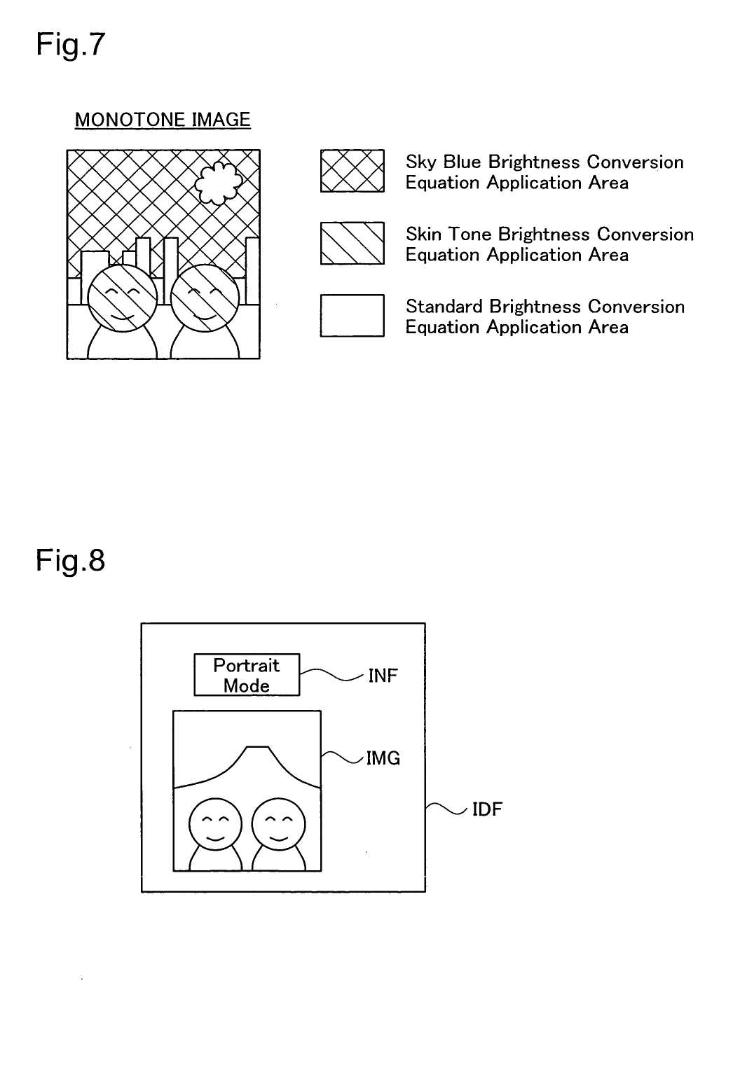

In Embodiments 1 and 2 hereinabove, a given brightness conversion equation is applied to all pixels; however, it is possible to instead apply different brightness conversion equations, depending on pixels. FIG. 7 shows an image portraying the sky above a city, together with human subjects.

In this Embodiment, in order to perform a monotone conversion process appropriate for such multiple subjects, a brightness conversion equation is established independently for pixels of each of the plurality of characteristic colors. Specifically, the brightness conversion equation adjusting module 224 (FIG. 2) prepares independent brightness conversion equations for pixel groups of each of the three characteristic colors (skin tone, green, and sky blue), on the basis of pixel proportion and threshold value for each.

Brightness conversion equation adjusting module 224 carries out determinations in relation to each of the three characteristic colors (skin tone, green, and sky blue), based on pixel proportion and threshold value of each. Determination is made under conditions analogous to those in FIG. 6(a). For characteristic colors whose proportion exceeds the threshold value, a brightness conversion equation suitable for the characteristic color (FIG. 6(b)) is prepared. For characteristic colors whose proportion falls below the threshold value, the standard brightness conversion equation is applied. Brightness converting module 222 applies the respective brightness conversion equation depending on the color of pixels in the color image data.

In the example shown in FIG. 7, a brightness conversion equation suitable for skin tone is applied to skin tone pixels. A brightness conversion equation suitable for sky blue is applied to sky blue pixels. For other pixels, the brightness conversion equation used in the case of standard color of note is applied. As a result, skin tone brightness is set to a higher level and sky brightness to a lower level, whereby it is possible to create vivid monotone image data featuring high contrast between human figures and the sky.

In this way, in this Embodiment 3, by employing brightness conversion equations according to pixel color in color image data, it is possible to carry out monotone conversion processing appropriate to a plurality of subjects, even when processing color image data that contains subjects of various kinds.

E. Embodiment 4:

The magnitude of the adjustment values Δkr, Δkg, Δkb in the brightness conversion equation may be variable values that vary according to pixel proportion of each characteristic color. For example, in the example depicted in FIGS. 6(a) and 6(b), magnitude of the absolute values of adjustment values Δkr, Δkg, Δkb can be adjusted to as to increase in association with larger magnitude of maximum pixel proportion. For example, adjustment may be performed such that where the sky blue proportion sky_rate is maximum among the three pixel proportions, Δkr is set greater, and Δkg and Δkb are set smaller (absolute values of Δkg and Δkb are set greater), the greater the sky blue proportion sky_rate is. By so doing, it is possible to effectively enhance contrast between a subject having the characteristic color and the surrounding area in cases where the proportion of pixels having a characteristic color is relatively large. In preferred practice, assignment of positive/negative to adjustment values Δkr, Δkg, Δkb will be maintained in accordance with establishment of brightness conversion equations corresponding to characteristic color at maximum pixel proportion.

The three pixel values R, G, B of the brightness conversion equation may be established as functions of pixel proportion of each characteristic color, without determining a color of note. Such a brightness conversion equation may be represented by the following computational equation, for example.

$$\begin{matrix}Y ( luminance ) = fr ( skin\_rate , green\_rate , sky\_rate ) \cdot R + \\ fg ( skin\_rate , green\_rate , sky\_rate ) \cdot G + \\ fb ( skin\_rate , green\_rate , sky\_rate ) \cdot B\end{matrix} \qquad ( Eq . 2 )$$

In the equation, fr, fb and fg are respectively functions of the pixel proportions skin_rate, green_rate, sky_rate of the there characteristic colors, and are weights for the three pixel values R, G, B.

In this way, by representing the brightness conversion equation in terms of functions of pixel proportions, it is possible to perform fine adjustment of the brightness conversion equation in association with color image data of various kinds. As a result, appropriate monotone conversion processes can be carried out on color image data of various kinds.

F. Embodiment 5:

FIG. 8 illustrates an arrangement of an image data file IDF utilizable by the image processing device. This image data file IDF contains shooting mode information INF and color image data IMG. Shooting mode information INF is related to operating mode (hereinafter termed shooting mode) settings when shot by a digital camera 100.

Some digital cameras allow shooting mode to be switched at the time of shooting, depending on whether the shooting scene is a portrait or landscape. One of a number of preset modes, such as standard mode, portrait mode, and landscape mode can be selected as the shooting mode according to the type of subject or other considerations. Standard mode is the default shooting condition (standard shooting condition) of digital camera 100. Frequently, the standard shooting condition is used as the setting for the digital camera 100 out-of-the-box. Also, certain digital cameras store information relating to shooting mode at the time of shooting (shooting mode information INF) as image data-related information relating to image data, in an image data file together with the image data per se. In this Embodiment, it is possible to use such image data files. One such file format is the Exif file format, for example.

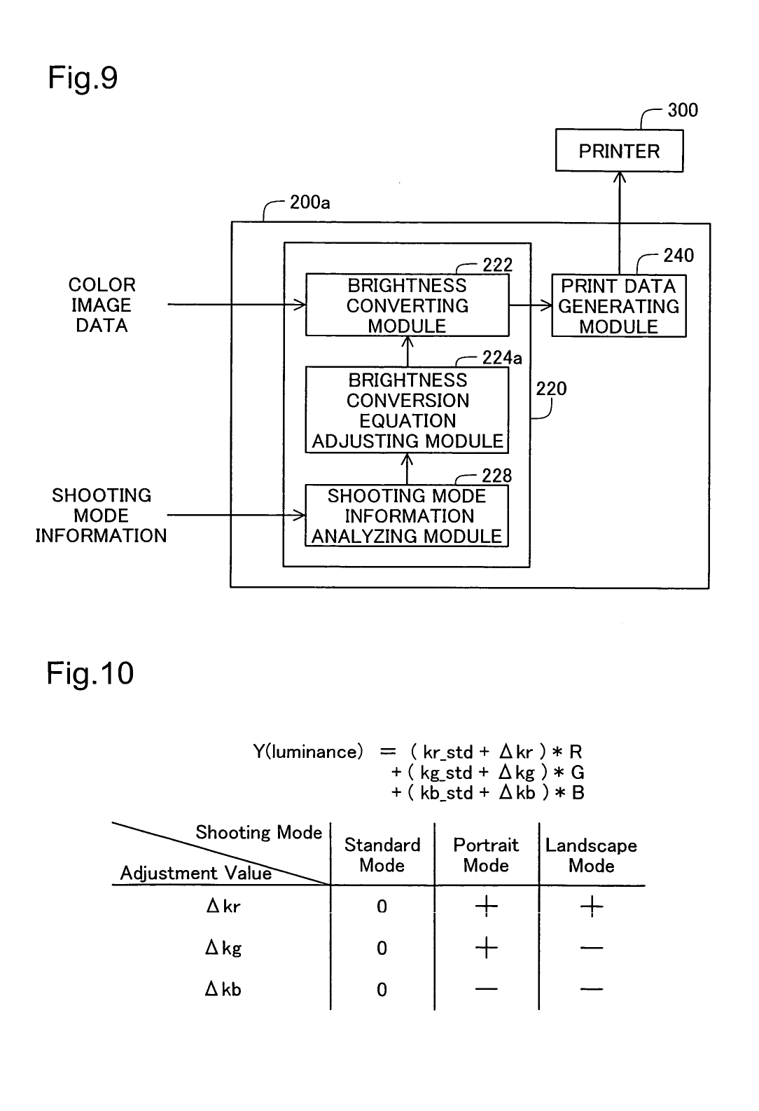

FIG. 9 is a block diagram showing the arrangement of a computer 200a in Embodiment 5. A difference from the computer 200 shown in FIG. 2 is that data processing module 220a is furnished with a shooting mode information analyzing module 228 rather than image data analyzing module 226. Shooting mode information analyzing module 228 analyzes shooting mode information INF contained in an image data file IDF and acquires the shooting mode. Brightness conversion equation adjusting module 224a adjusts the brightness conversion equation according to the acquired shooting mode. In this Embodiment, shooting mode information analyzing module 228 corresponds to the “operating mode determining module” of the invention.

FIG. 10 illustrates a brightness conversion equation adjusted by brightness conversion equation adjusting module 224a. A difference from the examples shown in FIG. 4(b) or FIG. 6(b) is that adjustment values Δkr, Δkg, Δkb are set according to shooting mode. In this Embodiment, in the case of standard mode, adjustment values Δkr, Δkg, Δkb are all set to zero.

In the case of portrait mode, in the same manner as where the color of note is skin tone in FIG. 6(b), adjustment values Δkr, Δkg of the red component R and green component G are set to positive values, while the adjustment value Δkb of the blue component B is set to a negative value. As a result, brightness of skin tone pixels in the image subsequent to conversion is set to a higher level than in standard mode.

In the case of landscape mode, in the same manner as where the color of note is sky blue in FIG. 6(b), adjustment value Δkr of the red component R is set to a positive value, while the adjustment values Δkg, Δkb of the green component G and blue component B are set to a negative value. As a result, brightness of sky blue pixels in the image subsequent to conversion is set to a lower level than in standard mode.

On the basis of a brightness conversion equation established in the manner shown in FIG. 10, the brightness converting module 222 generates monotone image data.

In this way, in this Embodiment 5, the brightness conversion equation can be adjusted automatically with reference to shooting mode information. As a result, monotone conversion processes appropriate for particular shooting modes can be performed.

G. Variations:

The invention is not limited to the Embodiments or embodiments set forth hereinabove, but may be reduced to practice in various modes without departing from the scope and spirit thereof. The following variations are possible, for example.

G1. Variation 1:

A data processing unit furnished with the image data analyzing module 226 shown in FIG. 2 and the shooting mode information analyzing module 228 shown in FIG. 9 may be employed. In this case, there may be employed an arrangement whereby, where the image data file stores shooting mode information INF, the monotone conversion process is carried out on the basis of shooting mode; or where shooting mode information INF is not stored, the monotone conversion process is carried out on the basis of the analysis of the image data. By means of this arrangement, monotone conversion processing appropriate to color image data may be carried out regardless of whether or not shooting mode information is present. An arrangement whereby where the shooting mode is standard mode the monotone conversion process is carried out on the basis of the analysis of the image data is also acceptable.

G2. Variation 2:

In the Embodiments hereinabove, characteristic color is defined on the basis of a hue range only, but may instead be defined on the basis of saturation and brightness as well. By so doing, characteristic color can be made to reflect more properly color representing a characteristic of a subject.

G3. Variation 3:

In the Embodiments hereinabove, characteristic color information representing pixel proportion is used as the color distribution information; however, color distribution information is not limited to characteristic color information, and generally may consist of any information relating to color bias in color image data. For example, it is acceptable to use the hue constituting the peak in a hue distribution as color distribution information, adjusting the brightness conversion equation so as to darken the brightness level of color having that hue. Conversely, it is acceptable also to adjusting the brightness conversion equation so as to lighten the brightness level of color constituting the peak in a hue distribution.

G4. Variation 4:

Monotone image data created by a monotone conversion process is not limited to utilization for printing, and may be used in any of various other applications. For example, it may be used for image output to an LCD display or CRT monitor, or to create an image data file storing monotone image data. By generating and reusing such an image data file, it is possible to utilize a monotone image even when using a device incapable of executing a monotone conversion process.

G5. Variation 5:

In the Embodiments hereinabove, a computer is used as the image processing device for executing the monotone conversion process, but an arrangement whereby the image output device executes the monotone conversion process may be used instead. For example, an arrangement whereby the control circuit (not shown) of printer 300 (FIG. 1) has the functions of the data processing module 220 and the print data generating module 240 is possible. Additionally, an arrangement whereby the printer 300 receives image data directly from a digital camera 100 via a cable, wireless link, memory card or other means will allow monotone images to be printed without the use of a computer 200. Accordingly, the user will easily be able to utilize high quality monotone images.

G6. Variation 6:

The term “digital camera” herein includes both digital still cameras that take still images, as well as digital video cameras that record motion video.

G7. Variation 7:

In the Embodiments hereinabove, some of the arrangements realized through software may instead be realized through hardware, and conversely some of the arrangements realized through hardware may instead be realized through software. For example, some of the functions of computer 200 (FIG. 2) may be executed by a control circuit (not shown) in printer 300.

G8. Variation 8:

In the Embodiments hereinabove, both image data per se and image data-related information are stored in the same image data file. In general, any arrangement providing an image data set where image data and image data-related information are associated with one another is acceptable.

The present application claims the priority based on Japanese Patent Application No. 2003-291329 filed on Aug. 11, 2003, which is herein incorporated by reference in its entirety.

1. An image processing method for performing monotone conversion of color image data, the method comprising the steps of:
(a) analyzing the color image data to create color distribution information relating to color bias in the color image data;
(b) adjusting, based on the color distribution information, a brightness conversion equation that is to be used in brightness conversion to convert pixel values of the color image data into pixel brightness values of monotone image data; and
(c) executing the brightness conversion in accordance with the adjusted brightness conversion equation.

2. An image processing method according to claim 1, wherein
the step (a) includes obtaining characteristic color information representing frequency of pixels having a specific hue in the color image data as the color distribution information, and
the step (b) includes adjusting the brightness conversion equation according to the characteristic color information.

3. An image processing method according to claim 2, wherein
the step (a) includes obtaining a plurality of sets of characteristic color information relating to mutually different hues, and
the step (b) includes selecting a brightness conversion equation from a plurality of mutually different brightness conversion equations prepared in advance, according to the plurality of sets of characteristic color information.

4. An image processing method according to claim 2, wherein
the brightness conversion equation calculates addition of a plurality of color components of each pixel in the color image data multiplied by respective coefficients, thereby obtaining brightness of each pixel of the monotone image data,
the step (a) includes obtaining a plurality of sets of characteristic color information relating to mutually different hues, and
the step (b) includes determining the coefficients for the color components in the brightness conversion equation according to the plurality of sets of characteristic color information.

5. An image processing method according to claim 1, wherein
the step (c) includes applying the adjusted brightness conversion equation to all pixels of the color image data.

6. An image processing method according to claim 1, wherein
the step (b) includes preparing a plurality of brightness conversion equations based on the color distribution information, and
the step (c) includes selecting one adjusted brightness conversion equation from the plurality of brightness conversion equations for each pixel according to pixel color of the color image data.

7. An image processing device for performing monotone conversion of color image data, the device comprising:
a data processing module for creating monotone image data from the color image data, wherein the data processing module includes:
a converting module for converting pixel values of the color image data into pixel brightness values of monotone image data according to a brightness conversion equation;
an image data analyzing module for the color image data to create color distribution information relating to color bias in the color image data; and
a brightness conversion equation adjusting module for adjusting the brightness conversion equation based on the color distribution information.

8. A computer program product for performing monotone conversion of color image data, the computer program product comprising:
a computer readable medium; and
a computer program stored on the computer readable medium, the computer program including:
a first computer program code for causing a computer to analyze the color image data to create color distribution information relating to color bias in the color image data;
a second computer program code for causing the computer to adjust, based on the color distribution information, a brightness conversion equation that is to be used in brightness conversion to convert pixel values of the color image data into pixel brightness values of monotone image data; and
a third computer program code for causing the computer to execute the brightness conversion in accordance with the adjusted brightness conversion equation.

9. An image processing method for performing monotone conversion of color image data, using color image data which has been generated by an image generating device and image data-related information which is associated with the color image data and which includes operating mode information pertaining to an operating mode of the image generating device at the time the color image data is generated, the method comprising the steps of:
(a) analyzing the operating mode information to determine the operating mode;
(b) adjusting, based on the operating mode, a brightness conversion equation that is to be used in brightness conversion to convert pixel values of the color image data into pixel brightness values of monotone image data; and
(c) executing the brightness conversion in accordance with the adjusted brightness conversion equation.

10. An image processing method according to claim 9, wherein the step (b) includes, if the operating mode is a specific mode suitable for a portrait image, increasing brightness of pixels of the monotone image data corresponding to skin color pixels of the color image data, to a brightness level greater than that in the case that the operating mode is a standard mode of the image generating device.

11. An image processing method according to claim 9, wherein the step (b) includes, if the operating mode is a specific mode suitable for a landscape image, lowering brightness of pixels of the monotone image data corresponding to sky blue color pixels of the color image data, to a brightness level darker than that in the case that the operating mode is a standard mode of the image generating device.

12. An image processing device for performing monotone conversion of color image data, using color image data which has been generated by an image generating device and image data-related information which is associated with the color image data and which includes operating mode information pertaining to an operating mode of the image generating device at the time the color image data is generated, the image device comprising:
a data processing module for creating monotone image data from the color image data and the operating mode information, wherein the data processing module includes:
a converting module for converting pixel values of the color image data into pixel brightness values of monotone image data according to a brightness conversion equation;
an operating mode determining module for analyzing the operating mode information to determine the operating mode; and
a brightness conversion equation adjusting module for adjusting the brightness conversion equation based on the operating mode determined by the operating mode determining module.

13. A computer program product for performing monotone conversion of color image data, using color image data which has been generated by an image generating device and image data-related information which is associated with the color image data and which includes operating mode information pertaining to an operating mode of the image generating device at the time the color image data is generated, the computer program product comprising:
a computer readable medium; and
a computer program stored on the computer readable medium, the computer program including:
a first computer program code for causing a computer to analyze the operating mode information to determine the operating mode;
a second computer program code for causing the computer to adjust, based on the operating mode, a brightness conversion equation that is to be used in brightness conversion to convert pixel values of the color image data into pixel brightness values of monotone image data; and
a third computer program code for causing the computer to execute the brightness conversion in accordance with the adjusted brightness conversion equation.
